(19) United States
(12) Patent Application Publication
(10) Pub. No.: US 2011/0096561 A1
(43) Pub. Date: Apr. 28, 2011

(54) VEHICLE LIGHT

(76) Inventor: Ryotaro OWADA, Tokyo (JP)

(21) Appl. No.: 12/911,699

(22) Filed: Oct. 25, 2010

(30) Foreign Application Priority Data
Oct. 23, 2009 (JP) 2009-243949

(51) Int. Cl. F21V 5/04; B60Q 1/04

(52) U.S. Cl. 362/521

(57) ABSTRACT

A vehicle light can resolve remarkable bright-dark boundaries formed between a far side and a near side of the light, thereby improving the near-side visibility for a driver. The vehicle light can include a light emitting device having an optical axis and a projection lens. The projection lens can include a light exiting surface that can project light beams emitted by the light emitting device while diffusing the light beams in both left and right directions when observed within a horizontal plane. The light exiting surface can include a left refraction surface that can project the light beams downward by a larger deflection angle with respect to a horizontal plane as the exit position of the light is farther away from the optical axis in the upper and lower directions when observed within a vertical plane. The light exiting surface can also include a right refraction surface that can project the light beams downward by a larger deflection angle with respect to the horizontal plane as the exit position is farther away from the optical axis in the upper and lower directions when observed within a vertical plane.

This application claims the priority benefit under 35 U.S.C. §119 of Japanese Patent Application No. 2009-243949 filed on Oct. 23, 2009, which is hereby incorporated in its entirety by reference.

### TECHNICAL FIELD

The presently disclosed subject matter relates to a vehicle light.

### BACKGROUND ART

Japanese Patent Application Laid-Open No. 2007-335301 (corresponding to U.S. Pat. No. 7,648,262) describes a direct projection type light having a light emitting device 14, a convex lens 12 disposed in front of the light emitting device 14. The convex lens 12 is configured for directly projecting light emitted from the light emitting device 14 forward. The convex lens 12 is also configured to project the light emitted from the light emitting device 14 approximately in parallel with each other when observed within a vertical plane (FIG. 1) while diffusing the light beams when observed within a horizontal plane (FIG. 2). The projected light can form a horizontally wide light distribution pattern PA in a front virtual plane (see FIG. 3 corresponding to FIG. 4 of Japanese Patent Application Laid-Open No. 2007-335301).

However, there is a remarkably clear bright-dark boundary formed between the formed light distribution pattern PA and its adjacent lower area, and the boundary may be erroneously recognized by a driver as a step on a road.

Furthermore, since the technique disclosed in Japanese Patent Application Laid-Open No. 2007-335301 can provide only a limited illumination area in the vertical direction (in the upper and lower directions), the lower area of the light distribution pattern PA is relatively dark, thereby deteriorating the near-side visibility.

### SUMMARY

The presently disclosed subject matter was devised in view of these and other problems and features and in association with the conventional art. An aspect of the presently disclosed subject matter can be to provide a vehicle light that can resolve the clear bright-dark boundary and to improve the near-side visibility.

According to another aspect of the presently disclosed subject matter, a vehicle light can include: a light emitting device having an optical axis extending in a front direction therefrom; and, a projection lens disposed on the optical axis, configured to project light beams emitted from the light emitting device. In this configuration, the projection lens can be configured to include a light incident surface and a light exiting surface on rear and front sides thereof, respectively, the light incident surface being configured to receive the light beams emitted from the light emitting device, the light exiting surface being configured to project the entering light forward. The light exiting surface can be configured to project the incident light beams emitted from the light emitting device and being incident on the light incident surface while diffusing the light beams in both right and left directions when observed within a horizontal plane. The light exiting surface can be configured to include a first refraction surface in a region on a travelling side of a road and a second refraction surface in a region on an opposite side of the road. The first refraction surface can be configured to project the incident light beams emitted from the light emitting device and being incident on the light incident surface on a lower region than a horizontal plane including the optical axis with the horizontal plane serving as an upper limit when observed within a vertical plane. The second refraction surface can be configured to project the incident light beams emitted from the light emitting device and being incident on the light incident surface on a lower region than a predetermined position below the horizontal plane with the predetermined position serving as an upper limit when observed within a vertical plane. The first refraction surface can be configured to deflect the light beams emitted from the light emitting device downward by a larger deflection angle with respect to the horizontal plane as an exit position of light beam is farther away from the optical axis in upper and lower directions. The second refraction surface can be configured to deflect the light beams emitted from the light emitting device downward by a larger deflection angle with respect to the horizontal plane as an exit position of light beam is farther away from the optical axis in the upper and lower directions.

According to still another aspect of the presently disclosed subject matter, a vehicle light can include: a light emitting device having an optical axis extending in a front direction therefrom; and a projection lens disposed on the optical axis, configured to project light beams emitted from the light emitting device. In this configuration, the projection lens can be configured to include a light incident surface and a light exiting surface on rear and front sides thereof, respectively, the light incident surface being configured to receive the light beams emitted from the light emitting device, the light exiting surface being configured to project the entering light forward; the light exiting surface can be configured to include an upper first refraction surface in an upper region on a travelling side of a road, a lower first refraction surface in a lower region on the travelling side of the road, an upper second refraction surface in an upper region on an opposite side of the road, and a lower second refraction surface in a lower region on the opposite side of the road; the upper first refraction surface and the upper second refraction surface can be configured so as to project the incident light beams emitted from the light emitting device and being incident on the light incident surface while diffusing in both right and left directions when observed within a horizontal plane; the lower first refraction surface and the lower second refraction surface can be configured so as not to project the incident light beams emitted from the light emitting device and being incident on the light incident surface on the opposite side of the road with respect to a vertical plane and so as to project the light beams on the traveling side of the road with respect to the vertical plane when observed within a horizontal plane; the upper first refraction surface, the lower first refraction surface, and the lower second refraction surface can be configured to project the incident light beams emitted from the light emitting device and being incident on the light incident surface on a lower region than a horizontal plane including the optical axis with the horizontal plane serving as an upper limit when observed within a vertical plane; the upper second refraction surface can be configured to project the incident light beams emitted from the light emitting device and being incident on the light incident surface on a lower region than a predetermined position below the horizontal plane with the predetermined position serving as an upper limit when observed within a vertical plane; the upper first refraction surface, the lower first refraction surface, and the lower second refraction surface can be configured to deflect the light beams emitted from the light emitting device downward by a larger deflection angle with respect to the horizontal plane as an exit position of light beam is farther away from the optical axis in upper and lower directions; and the upper second refraction surface can be configured to deflect the light beams emitted from the light emitting device downward by a larger deflection angle with respect to the horizontal plane as an exit position of light beam is farther away from the optical axis in the upper direction.

In any of the vehicle lights according to the above aspects, the projection lens can be configured to include a first prism portion and a second prism portion, the first prism portion being disposed on a periphery of the light incident surface and the light exiting surface on the travelling side of road with respect to the optical axis, the second prism portion being disposed on the periphery of the light incident surface and the light exiting surface on the opposite side with respect to the optical axis. The first prism portion can be configured to include a first prism light incident surface and a first prism light exiting surface on the rear and front sides thereof, respectively, the first prism light incident surface being configured to receive the light beams emitted from the light emitting device, the first prism light exiting surface being configured to project the entering light forward. The second prism portion can be configured to include a second prism light incident surface and a second prism light exiting surface on the rear and front sides thereof, respectively, the second prism light incident surface being configured to receive the light beams emitted from the light emitting device, the second prism light exiting surface being configured to project the entering light forward. The first prism light exiting surface can be configured so as not to project the incident light beams emitted from the light emitting device and being incident on the first prism light incident surface on the opposite side of the road with respect to a vertical plane and so as to project the light beams on the traveling side of the road with respect to the vertical plane when observed within a horizontal plane. The first prism light exiting surface can be configured to project the incident light beams emitted from the light emitting device and being incident on the first prism light incident surface on a lower region than a predetermined position below the horizontal plane including the optical axis with the predetermined position serving as an upper limit when observed within a vertical plane. The first prism light exiting surface can be configured to deflect the light beams emitted from the light emitting device downward by a larger deflection angle with respect to the horizontal plane as an exit position of light beam is farther away from the optical axis in upper and lower directions. The second prism light exiting surface can be configured so as not to project the incident light beams emitted from the light emitting device and being incident on the second prism light incident surface on the travelling side of the road with respect to the vertical plane and so as to project the light beams on the opposite side of the road with respect to the vertical plane when observed within a horizontal plane. The second prism light exiting surface can be configured to project the incident light beams emitted from the light emitting device and being incident on the second prism light incident surface on a lower region than a predetermined position below the horizontal plane including the optical axis with the predetermined position serving as an upper limit when observed within a horizontal plane. The second prism light exiting surface can be configured to deflect the light beams emitted from the light emitting device downward by a larger deflection angle with respect to the horizontal plane as an exit position of light beam is farther away from the optical axis in the upper and lower directions.

According to the one aspect, the first refraction surface can be configured so as to project the light beams emitted from the light emitting device downward by a larger deflection angle with respect to the horizontal plane as the exit position is farther away from the optical axis in the upper and lower directions. Also, the second refraction surface can be configured so as to project the light beams emitted from the light emitting device downward by a larger deflection angle with respect to the horizontal plane as the exit position is farther away from the optical axis in the upper and lower directions. Thereby, the light distribution pattern can be formed so as to extend downward. Accordingly, many remarkable bright-dark boundaries formed between the farther side and the nearer side can be resolved, thereby improving the near-side visibility for a driver.

In particular, the technique disclosed in Japanese Patent Application Laid-Open No. 2007-335301 may not project light beams on a wider area required for forming a low beam light distribution pattern. In the conventional technique, the solution is typically to combine another lamp for illuminating a diffused region. On the contrary, the vehicle light made in accordance with the principles of the presently disclosed subject matter can illuminate a wider area by using a single vehicle light without necessarily requiring a combination with another lamp, while satisfying desired performances as a vehicle light.

According to the other aspect, the upper first refraction surface, the lower first refraction surface, and the lower second refraction surface can be configured so as to project light beams emitted from the light emitting device downward by a larger deflection angle with respect to the horizontal plane as the exit position is farther away from the optical axis in the upper and lower directions. Also, the upper second refraction surface can be configured so as to project the light beams emitted from the light emitting device downward by a larger deflection angle with respect to the horizontal plane as the exit position is farther away from the optical axis in the upper and lower directions. Thereby, the light distribution pattern can be formed so as to extend downward. Accordingly, many remarkable bright-dark boundaries formed between the farther side and the nearer side can be resolved, thereby improving the near-side visibility for a driver.

Furthermore, the luminous flux can be increased on the travelling side of the road, thereby improving the long-distance visibility.

According to the still another aspect, since the projection lens can be prevented from being increased in thickness thereof, an increase in the aperture of the lens can be realized. As a result, it is achieved to form a brighter and wider light distribution pattern.

In the above configuration, the vehicle light can further include a support plate on a front surface of which the light emitting device is mounted, and heat dissipation fins provided to the support plate on a rear surface thereof, and the projection lens can have leg portions that are secured to the support plate. By configuring the light emitting device in such a manner, the generated heat can be effectively dissipated, thereby preventing the uneven light distribution from being formed.

The vehicle light configured as described above can have the light incident surface formed as a cylindrical concave surface curved horizontally so that a rotation axis of the cylindrical concave surface extends in a vertical direction. This configuration can assist the formation of the desired light distribution pattern more effectively.

### BRIEF DESCRIPTION OF DRAWINGS

These and other characteristics, features, and advantages of the presently disclosed subject matter will become clear from the following description with reference to the accompanying drawings, wherein:

FIG. 1 is a vertical cross sectional view illustrating a conventional vehicle light;

FIG. 2 is a horizontal cross sectional view illustrating the conventional vehicle light of FIG. 1;

FIG. 3 is a graph illustrating the light distribution pattern PA formed by the conventional vehicle light of FIG. 1;

FIG. 4 is a front view illustrating a direct projection vehicle light according to one exemplary embodiment of the presently disclosed subject matter;

FIG. 5 is a cross sectional view of the vehicle light taken along line II-II in FIG. 4;

FIG. 6 is a cross sectional view of the vehicle light taken along line III-III in FIG. 4;

FIG. 7 is a cross sectional view of the vehicle light taken along line IV-IV in FIG. 4;

FIG. 8 is a front view illustrating the light source of the vehicle light of FIG. 4;

FIG. 9 is a schematic perspective view illustrating a light distribution pattern formed by the direct projection vehicle light of FIG. 4 on a virtual plane in front thereof;

FIG. 10 is a schematic perspective view illustrating the light distribution pattern formed by the direct projection vehicle light of FIG. 4 on a virtual plane in front thereof;

FIG. 11 is a front view illustrating a direct projection vehicle light according to another exemplary embodiment of the presently disclosed subject matter;

FIG. 12 is a cross sectional view of the vehicle light of FIG. 11 taken along line IX-IX;

FIG. 13 is a cross sectional view of the vehicle light of FIG. 11 taken along line X-X;

FIG. 14 is a cross sectional view of the vehicle light of FIG. 11 taken along line XI-XI;

FIG. 15 is a cross sectional view of the vehicle light of FIG. 11 taken along line XII-XII;

FIG. 16 is a schematic perspective view illustrating the light distribution pattern formed by the direct projection vehicle light of FIG. 11 on a virtual plane in front thereof;

FIG. 17 is a schematic perspective view illustrating the light distribution pattern formed by the direct projection vehicle light of FIG. 11;

FIG. 18 is a schematic perspective view illustrating the light distribution pattern formed by the direct projection vehicle light of FIG. 11;

FIG. 19 is a schematic perspective view illustrating the light distribution pattern formed by the direct projection vehicle light of FIG. 11;

FIG. 20 is a schematic perspective view illustrating the light distribution pattern formed by the direct projection vehicle light of FIG. 11;

FIG. 21 is a perspective view illustrating a direct projection vehicle light according to still another exemplary embodiment of the presently disclosed subject matter;

FIG. 22 is a front view illustrating the direct projection vehicle light of FIG. 21;

FIG. 23 is a cross sectional view of the vehicle light of FIG. 22 taken along line XX-XX;

FIG. 24 is a cross sectional view of the vehicle light of FIG. 22 taken along line XXI-XXI;

FIG. 25 is a diagram of a light distribution pattern formed by the direct projection vehicle light of FIG. 22 on a virtual plane; and

FIG. 26 is a diagram of the light distribution pattern formed by the direct projection vehicle light of a modified embodiment of FIG. 22 on a virtual plane.

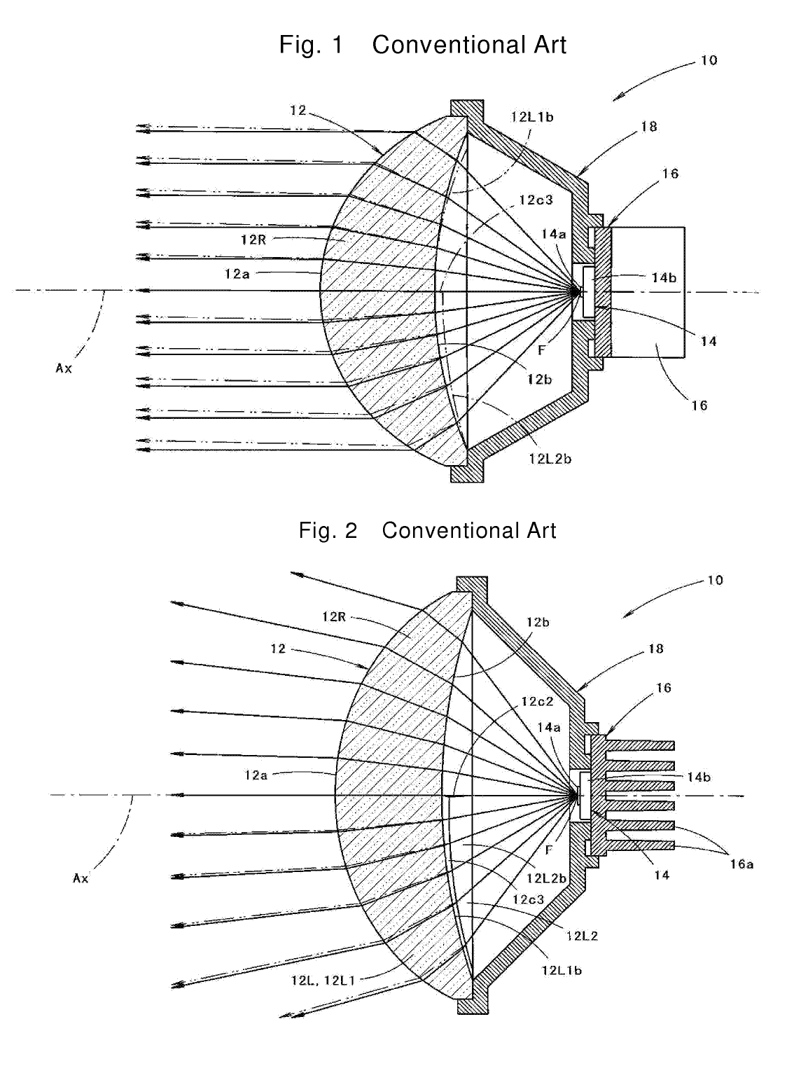

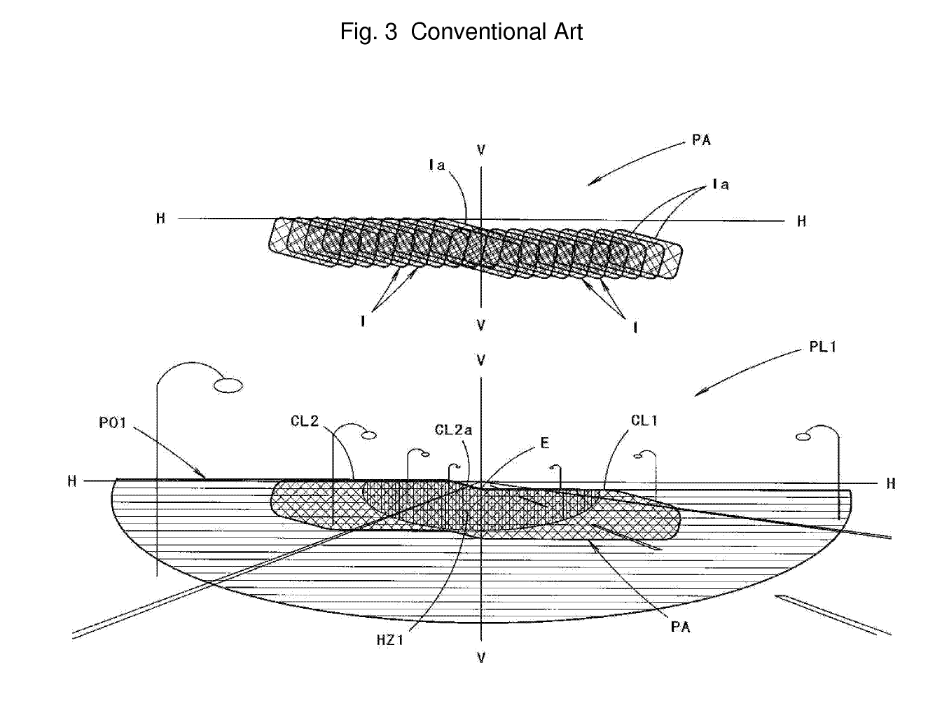

### DESCRIPTION OF EXEMPLARY EMBODIMENTS

A description will now be made below to vehicle lights of the presently disclosed subject matter with reference to the accompanying drawings in accordance with exemplary embodiments. It should be noted that the following exemplary embodiments include various technical features that can be used to embody the presently disclosed subject matter, but that the presently disclosed subject matter should not be limited to the illustrated exemplary embodiments and examples.

In the present specification, the directions “up,” “down (low),” “front,” “rear,” “left,” and “right” shall mean the directions “up,” “down (low),” “front,” “rear,” “left,” and “right” in the state where the direct projection vehicle light is installed on a vehicle body for left-hand traffic. Accordingly, when a side is defined by “a travelling side of a road,” it means the left side of the road or the vehicle body. When a side is defined by “an opposite side of the road,” it means the right side of the road or the vehicle body. However, the presently disclosed subject matter is not limited thereto, and if the vehicle is for right-hand traffic, the definitions may be changed vice versa.

### First Exemplary Embodiment

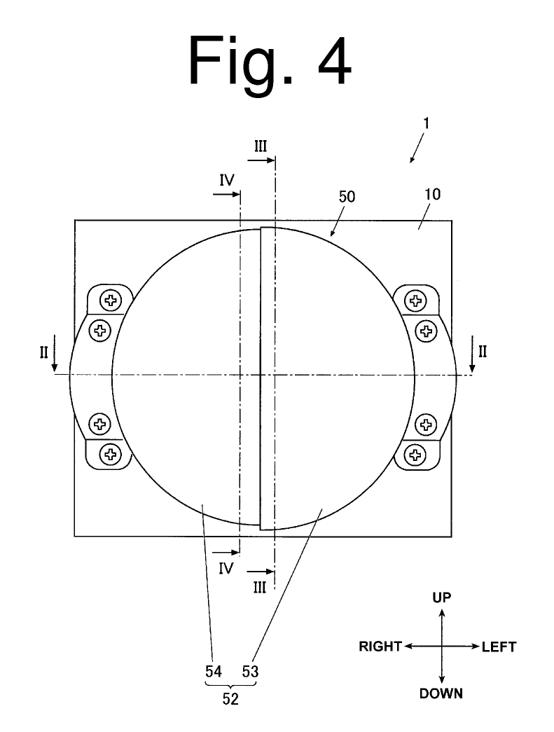

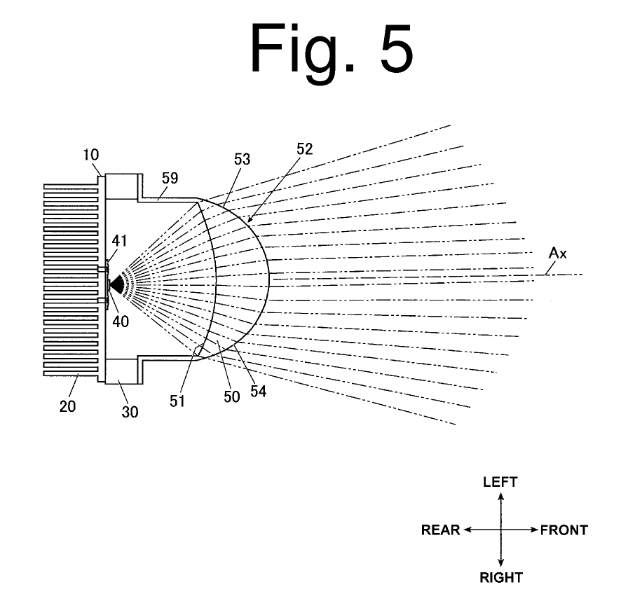

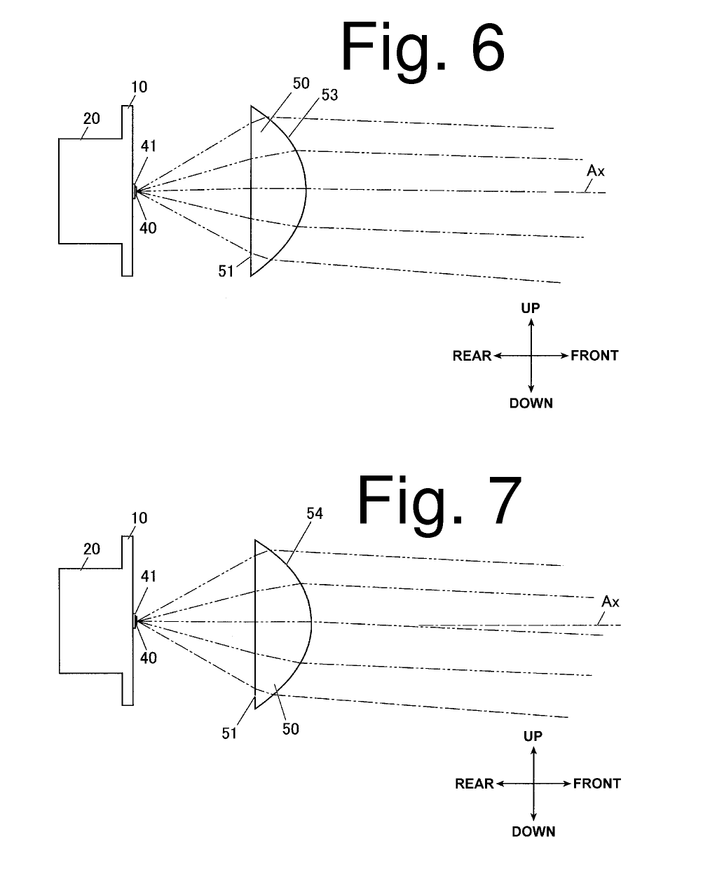

FIG. 4 is a front view illustrating a direct projection vehicle light according to one exemplary embodiment of the presently disclosed subject matter. FIG. 5 is a cross sectional view of the vehicle light taken along line II-II in FIG. 4. FIG. 6 is a cross sectional view of the vehicle light taken along line III-III in FIG. 4. FIG. 7 is a cross sectional view of the vehicle light taken along line IV-IV in FIG. 4.

In the illustrated exemplary embodiment, the direct projection vehicle light 1 is used for a low beam vehicle headlamp for left-hand traffic. Accordingly, the right side shall correspond to the opposite side of the road (oncoming car lane) whereas the left side shall correspond to the traveling side road (traveling car lane).

As shown, the direct projection vehicle light 1 can include a support plate 10, a plurality of heat dissipation fins 20, a lens holder 30, a light emitting device 40, and a projection lens 50, and can have an optical axis Ax.

The support plate 10 can be disposed along the vertical plane orthogonal to the optical axis Ax of the direct projection vehicle light 1. The plurality of heat dissipation fins 20 can be arranged to protrude from the rear surface of the support plate 10.

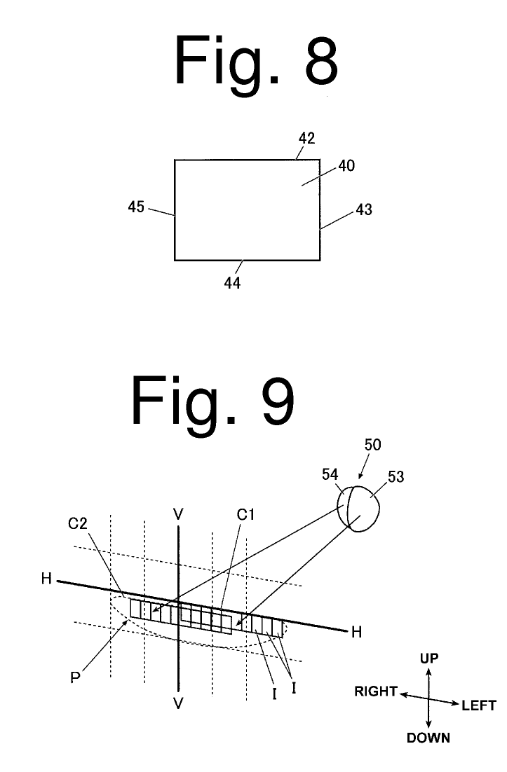

The light emitting device 40 can be a light emitting diode and can be mounted on the substrate 41, and the resulting assembly can be disposed on the front surface of the support plate 10. Specifically, the substrate 41 can be fixed on the front surface of the support plate 10 by means of screws, an adhesive or the like fixing member so that the light emitting device 40 faces forward. FIG. 8 is a front view illustrating the light emitting device 40. When being viewed from the front side, the light emitting device 40 can be a rectangular shape having short sides 43 and 45 and long sides 42 and 44. The light emitting device 40 can be arranged so that the short sides 43 and 45 or the long sides 42 and 44 are horizontal with respect to the horizontal plane, whereby the light emitting device 40 can be arranged long in the vertical or horizontal direction. The optical axis Ax of the direct projection vehicle light 1 can extend from a predetermined point of the light emitting device 40 (for example, the center of the light emitting device 40, the center lower side of the device, or the like) in a horizontally forward direction.

The lens holder 30 can be disposed on the front surface of the support plate 10 so as to surround the light emitting device 40. On the other hand, the projection lens 50 can have leg portions 59 on its peripheral edge at predetermined positions. The leg portions 59 can extend rearward and the protruded ends of the leg portions 59 can be fixed to the support plate 10 so that the lens holder 30 is sandwiched between the support plate 10 and the leg portions 59. In another embodiment, the support plate 10 and the lens holder 30 may be an integral part.

The projection lens 50 can be disposed on the optical axis Ax that extends forward from the light emitting device 40. The projection lens 50 can be a convex lens configured to project direct light from the light emitting device 40 forward. The projection lens 50 can have a light incident surface 51 and a light exiting surface 52 on the rear and front sides thereof, respectively. The light incident surface 51 can receive direct light emitted from the light emitting device 40. The light exiting surface 52 can project the entering light forward. The rear light incident surface 51 can have a cylindrical concave surface curved horizontally so that the rotation center axis extends in the vertical direction. The light exiting surface 52 can be an aspherical convex surface.

In FIG. 5, the chain double-dashed line denotes light beams emitted from the light emitting device 40 at a predetermined position (for example, the center of the light emitting device 40, the center lower side of the device 40, or the like). As shown in FIG. 5, the light exiting surface 52 of the projection lens 50 can be configured to project the incident light beams emitted from the predetermined position of the light emitting device 40 and which are incident on the light incident surface 51 while diffusing the light beams in both right and left directions when observed within a horizontal plane.

As shown in FIGS. 4 and 5, the light exiting surface 52 can include a first refraction surface 53 in a left region (on the travelling side) and a second refraction surface 54 in a right region (on the opposite side of the road).

In FIGS. 6 and 7, the chain double-dashed line denotes light beams emitted from the light emitting device 40 at a predetermined position. As shown in FIGS. 6 and 7, the projection lens 50 can project incident light beams emitted from the light emitting device 40 (at the predetermined position) and which are incident on the light incident surface 51 “not on a region” above the horizontal plane within a vertical plane but on a region below the horizontal plane and along the horizontal plane when observed within a vertical plane. Specifically, the first (left side) refraction surface 53 can project incident light beams emitted from the light emitting device 40 and which are incident on the light incident surface 51 “not on a region” above the horizontal plane within a vertical plane but on a region below the horizontal plane and along the horizontal plane when observed within a vertical plane. On the other hand, the second (right side) refraction surface 54 can project incident light beams emitted from the light emitting device 40 and which are incident on the light incident surface 51 “not on a region” above the horizontal plane within a vertical plane but on a region below the horizontal plane when observed within a vertical plane. In this case, as shown in FIGS. 6 and 7, the second refraction surface 54 can deflect the incident light beams more downward than the first refraction surface 53.

As shown in FIG. 6, the light beams emitted from the light emitting device 40 and which are projected through the first refraction surface 53 can be deflected downward by a larger deflection angle with respect to the horizontal plane as the exit position is farther away from the optical axis Ax in the upper and lower directions. As shown in FIG. 7, the light beams emitted from the light emitting device 40 and which are projected through the second refraction surface 54 can also be deflected downward by a larger deflection angle with respect to the horizontal plane as the exit position is farther away from the optical axis Ax in the upper and lower directions.

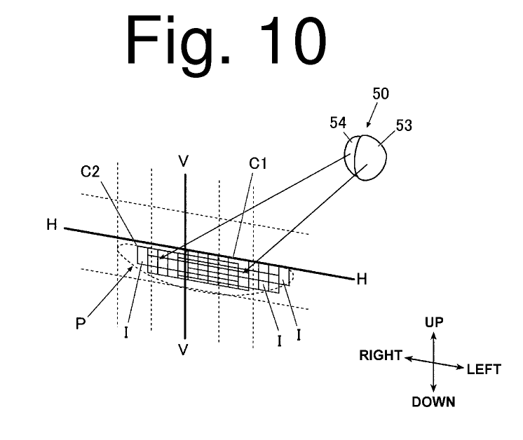

FIGS. 9 and 10 each are a schematic perspective view illustrating a light distribution pattern P formed by the direct projection vehicle light 1 on a virtual plane assumed to be positioned away from the direct projection vehicle light 1 by a predetermined distance. FIG. 9 illustrates the light distribution pattern formed by the light beams projected from the refraction surfaces near the horizontal plane. FIG. 10 illustrates the light distribution pattern formed by the light beams projected from the entire refraction surface. In FIGS. 9 and 10 (and some other drawings), the H-H line denotes an intersection line between the horizontal plane including the optical axis Ax and the virtual plane, and the V-V line denotes an intersection line between the vertical plane including the optical axis Ax and the virtual plane.

The light distribution pattern P formed by the direct projection vehicle light 1 shown in FIGS. 9 and 10 can be a low beam light distribution pattern for the left-hand traffic. The light distribution pattern P can have cut-off lines C1 and C2 at its upper edge. The cut-off line C1 is formed on the traveling side (left side) with respect to the V-V line so as to extend horizontally along the H-H line whereas the cut-off line C2 is formed on the opposite side (right side) with respect to the V-V line so as to horizontally extend slightly below the H-H line.

As shown in FIG. 9, the reverse projection image I of the light emitting device 40 can be projected by the projection lens 50 in the left and right directions on the virtual plane. This arrangement can be achieved by the light beams emitted from the light emitting device 40 which are diffused in the left and right directions by the light exiting surface 52 when observed within a horizontal plane. Thereby, the light distribution pattern P can be formed so as to extend in the left and right directions from the V-V line as shown in FIGS. 9 and 10.

As shown in FIG. 10, the reverse projection image I of the light emitting device 40 can be projected on the virtual screen by the projection lens 50 so as to be arranged in the vertical direction below the H-H line. The reverse projection image I of the light emitting device 40 by the projection lens 50 near the horizontal plane including the optical axis Ax can be arranged near the H-H line, and can be deflected more downward from the H-H line as the exit position is farther away from the horizontal plane in the upper and lower directions. This is because the light beams emitted from the light emitting device 40 are projected from the refraction surfaces 53 and 54 downward by a larger deflection angle with respect to the horizontal plane as the exit position is farther away from the optical axis Ax in the upper and lower directions. Accordingly, the light distribution pattern P can be formed to extend downward from the H-H line as shown in FIGS. 9 and 10.

Furthermore, the light distribution pattern P can have a brighter area as the pattern approaches the H-H line whereas it can have a darker area as it is downwardly farther away from the H-H line. This is because the light beams emitted from the light emitting device 40 can be projected from the refraction surfaces 53 and 54 downward by a larger deflection angle with respect to the horizontal plane as the exit position is farther away from the optical axis Ax in the upper and lower directions.

When the reverse projection image I of the light emitting device 40 is projected by the projection lens 50 so as to be arranged in the right and left directions, the cut-off lines C1 and C2 can be formed by the lower side of the light emitting device 40. Specifically, the cut-off line C1 can be formed by the projection image of the lower side and around there of the light emitting device 40 through the refraction surface 53 while the cut-off line C2 can be formed by the projection image of the lower side and around there of the light emitting device 40 through the refraction surface 54.

The right refraction surface 54 can be configured so as to deflect the exiting light beams downward to a greater extent than the left refraction surface 53. Namely, the refraction surface 53 can project the incident light beams emitted from the light emitting device 40 which are incident on the light incident surface 51 on a region on or below the H-H line (cut-off line C1) as an upper limit when observed within a vertical plane. On the other hand, the refraction surface 54 can project the incident light beams emitted from the light emitting device 40 which are incident on the light incident surface 51 on a region on or below a predetermined position (corresponding to the cut-off line C2) below the H-H line, with the predetermined position being an upper limit when observed within a vertical plane. Accordingly, the cut-off line C1 can be disposed above the cut-off line C2.

As described above, the direct projection vehicle light 1 can form the predetermined light distribution pattern P. In this case, the incident light beams emitted from the light emitting device 40 and which are projected through the refraction surface 53 (or 54) can be deflected downward by a larger deflection angle as the exit position is farther away from the optical axis Ax in the upper and lower directions. Therefore, the light distribution pattern P can be formed to extend from H-H line downward, and it has a darker area as it is downwardly farther away from the H-H line. This means that there may be no remarkable bright-dark boundary formed between the farther side and the nearer side, thereby possibly improving the near-side visibility for a driver.

Since the cut-off line C1 can be formed above the cut-off line C2, the visibility near the traveling side road can be ensured while glare light can be prevented from being generated toward the opposite side of the road. Accordingly, the direct projection vehicle light 1 can be utilized as a low beam headlamp.

The present exemplary embodiment has dealt with the case where the direct projection vehicle light 1 is for the left-hand traffic, which is not limitative. If the direct projection vehicle light 1 is used as that for the right-hand traffic, the design can be reversed horizontally.

The present exemplary embodiment has dealt with the case where the light incident surface 51 has a cylindrical surface, which is not limitative. The light incident surface 51 may have a flat surface, a spherical surface, an aspherical surface, a free curved surface, or other known alternatively shaped surface. The light exiting surface 52 can have a curved surface corresponding to the light incident surface 51 so that the desired refraction can be achieved on the exiting light beams through the light exiting surface 52.

### Second Exemplary Embodiment

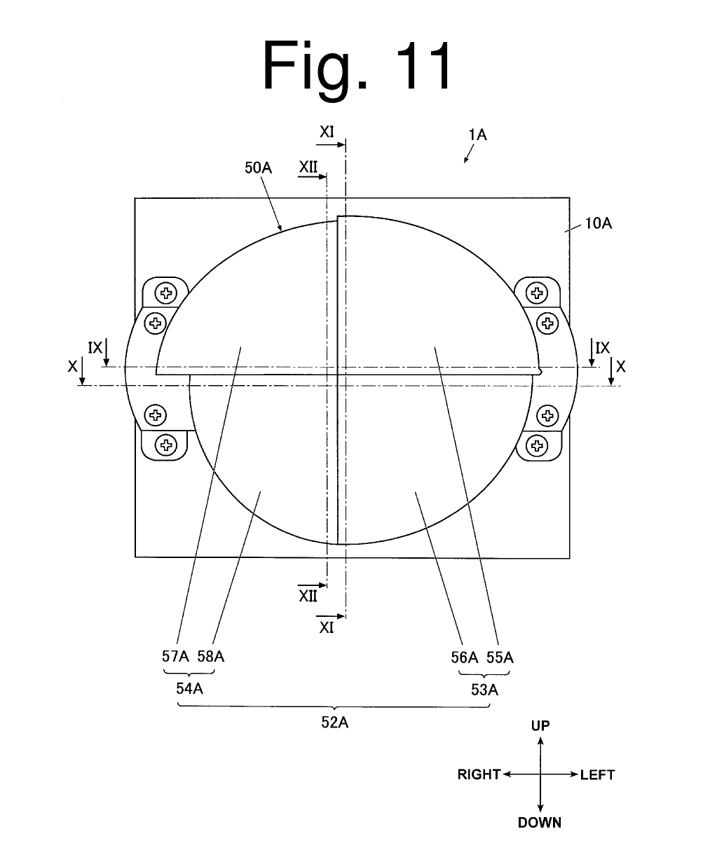

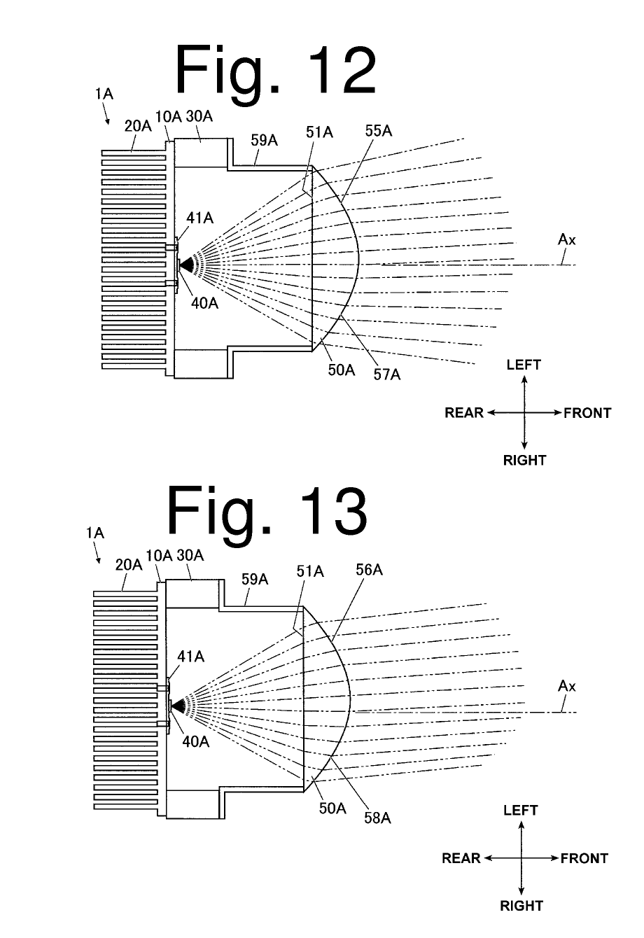

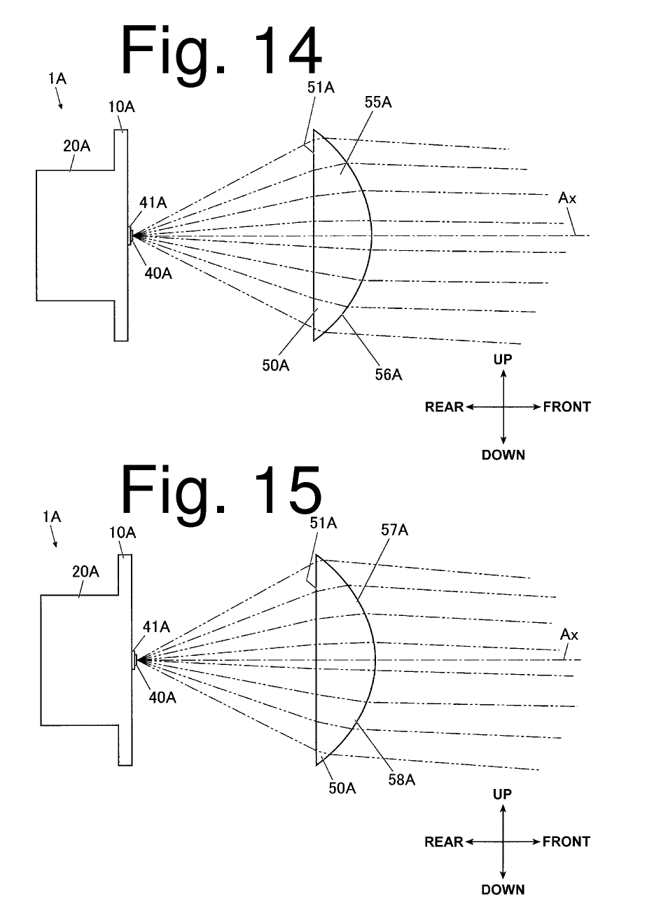

FIG. 11 is a front view illustrating a direct projection vehicle light 1A according to another exemplary embodiment of the presently disclosed subject matter. FIG. 12 is a cross sectional view illustrating the vehicle light 1A taken along line IX-IX in FIG. 11. FIG. 13 is a cross sectional view illustrating the vehicle light 1A taken along line X-X in FIG. 11. FIG. 14 is a cross sectional view illustrating the vehicle light taken along line XI-XI in FIG. 11. FIG. 15 is a cross sectional view illustrating the vehicle light taken along line XII-XII in FIG. 11.

In the illustrated exemplary embodiment, the direct projection vehicle light 1A is used for a low beam vehicle headlamp for the left-hand traffic.

As shown, the direct projection vehicle light 1A can include a support plate 10A, a plurality of heat dissipation fins 20A, a lens holder 30A, a light emitting device 40A, a projection lens 50A, and can have an optical axis Ax.

The support plate 10A and the plurality of heat dissipation fins 20A can be provided in the same or similar manner as in the first exemplary embodiment.

The light emitting device 40A can be disposed via a substrate 41A on the front surface of the support plate 10A in the same or similar manner as in the first exemplary embodiment. In this instance, the shape, arranged position, and arranged direction of the light emitting device 40A can be the same as those of the first exemplary embodiment.

The projection lens 50A can be attached to the support plate 10A by means of leg portions 59A and the lens holder 30A and disposed in front of the light emitting device 40A in the same or similar manner as in the first exemplary embodiment.

The projection lens 50A can be disposed on the optical axis Ax that extends forward from the light emitting device 40A. The projection lens 50A can be a convex lens so as to project direct light received from the light emitting device 40A forward. The projection lens 50A can have a light incident surface 51A and a light exiting surface 52A on the rear and front side thereof, respectively. The light incident surface 51A can receive the direct light emitted from the light emitting device 40A. The light exiting surface 52A can project the light forward. In this exemplary embodiment, the rear light incident surface 51A can be a flat plane orthogonal to the optical axis Ax.

The light exiting surface 52A can be an aspherical convex surface. As shown in the drawings, the light exiting surface 52A can include a left region 53A and a right region 54A. The left region 53A can include a first refraction surface 55A in an upper region and a second refraction surface 56A in a lower region. The right region 54A can include a third refraction surface 57A in an upper region and a fourth refraction surface 58A in a lower region.

In FIG. 12, the chain double-dashed line denotes light beams emitted from the light emitting device 40A at a predetermined position (for example, the center of the light emitting device 40A, the center lower side of the device 40A, or the like). As shown in FIG. 12, the refraction surfaces 55A and 57A of the projection lens 50A can be configured so as to project the incident light beams emitted from the predetermined position of the light emitting device 40A and which are incident on the light incident surface 51A, while diffusing the light beams in both right and left directions when observed within a horizontal plane.

In FIG. 13, the chain double-dashed line denotes light beams emitted from the light emitting device 40A at a predetermined position (for example, the center of the light emitting device 40A, the center lower side of the device 40A, or the like). As shown in FIG. 13, the refraction surface 56A can be configured so as not to project the incident light beams emitted from the predetermined position of the light emitting device 40A and which are incident on the light incident surface 51A rightward with respect to the vertical plane but so as to project the light beams leftward while diffusing the light beams leftward when observed within a horizontal plane.

The refraction surface 58A can be configured so as not to project the incident light beams emitted from the predetermined position of the light emitting device 40A and which are incident on the light incident surface 51A rightward with respect to the vertical plane but so as to project the light beams leftward when observed within a horizontal plane. The light beams emitted from the light emitting device 40A at the predetermined position and which are projected through the refraction surface 58A can be deflected leftward by a larger deflection angle with respect to the vertical plane as the exit position is farther away from the optical axis Ax in the right direction.

In FIGS. 14 and 15, the chain double-dashed line denotes light beams emitted from the light emitting device 40A at a predetermined position. As shown in FIGS. 14 and 15, the projection lens 50A can project incident light beams which are emitted from the light emitting device 40A at the predetermined position and which are incident on the light incident surface 51A “not on a region” above the horizontal plane within a vertical plane but on a region below the horizontal plane and along the horizontal plane when observed within a vertical plane. Specifically, the left refraction surfaces 55A and 56A and the right refraction surface 58A can project incident light beams emitted from the light emitting device 40A “not on a region” above the horizontal plane within a vertical plane but on a region below the horizontal plane and along the horizontal plane when observed within a vertical plane. On the other hand, the right refraction surface 57A can project incident light beams emitted from the light emitting device 40A “not on a region” above the horizontal plane within a vertical plane but on a region below the horizontal plane when observed within a vertical plane. In this case, as shown in FIGS. 14 and 15, the right refraction surface 57A can deflect the incident light beams lower than the left refraction surfaces 55A and 56A. In the context of this disclosure, the phrase “not on a region” should be understood to mean that the some or all subject light is directed to avoid said region, but that some or all of the subject light may or may not still reach such region.

As shown in FIG. 14, the light beams emitted from the light emitting device 40A at the predetermined position and being projected through the left refraction surfaces 55A and 56A can be deflected downward by a larger deflection angle with respect to the horizontal plane as the exit position is farther away from the optical axis Ax in the upper and lower directions. Similarly, as shown in FIG. 15, the light beams emitted from the light emitting device 40A at the predetermined position and being projected through the right refraction surface 57A can also be deflected downward by a larger deflection angle with respect to the horizontal plane as the exit position is farther away from the optical axis Ax in the upper direction. Furthermore, as shown in FIG. 15, the light beams emitted from the light emitting device 40A at the predetermined position and being projected through the right refraction surface 58A can also be deflected downward by a larger deflection angle with respect to the horizontal plane as the exit position is farther away from the optical axis Ax in the lower direction.

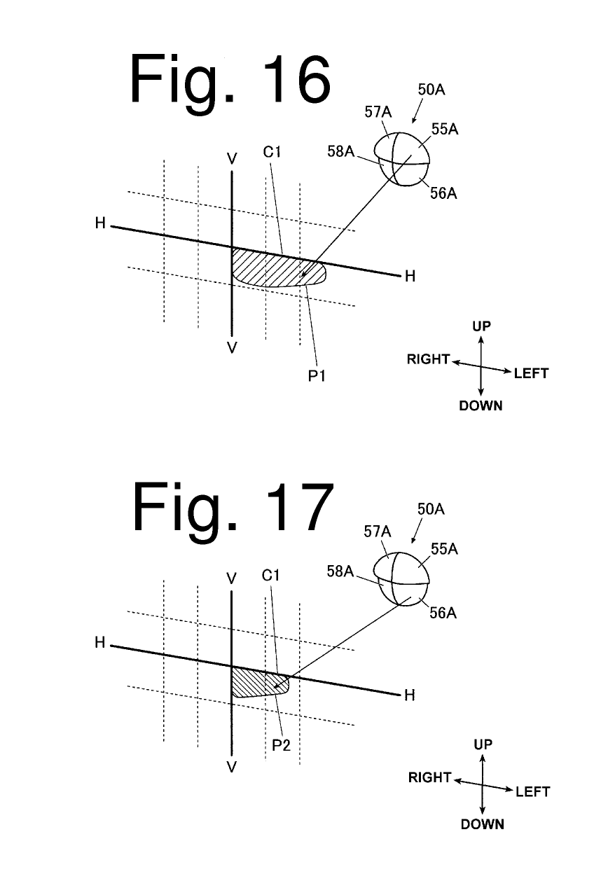

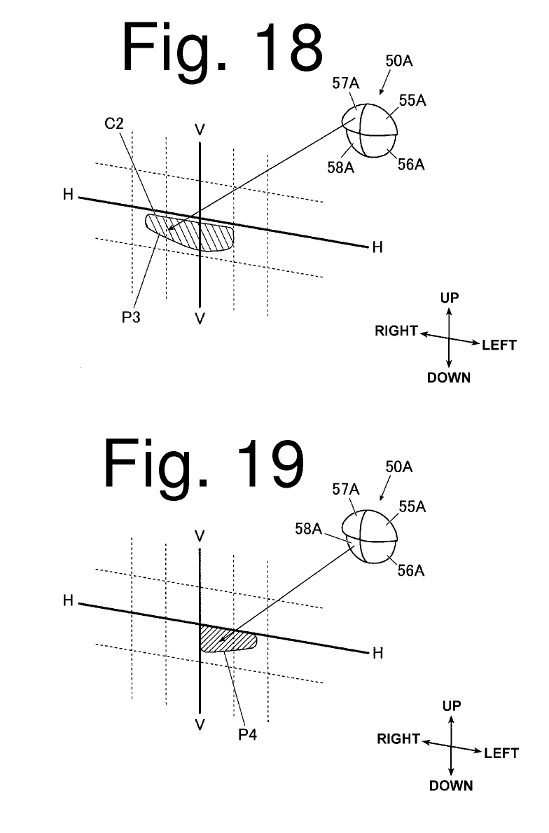

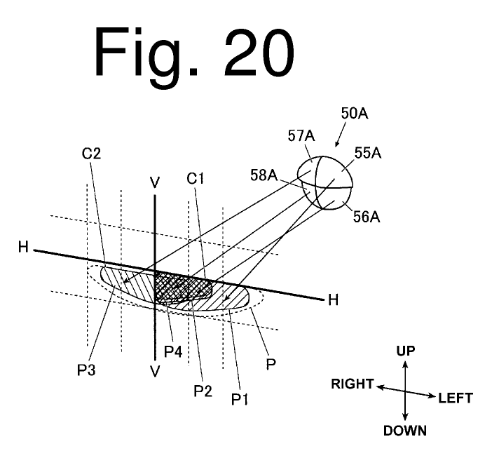

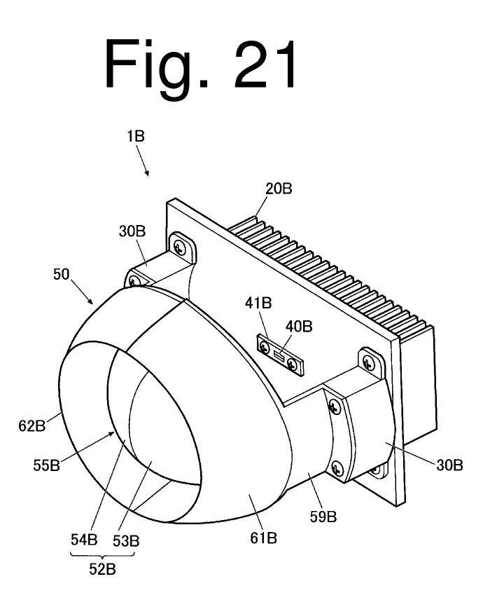

FIGS. 16 and 20 are each a schematic perspective view illustrating a light distribution pattern P formed by the direct projection vehicle light 1A on a virtual plane assumed to be positioned away from the direct projection vehicle light 1A by a predetermined distance. In FIGS. 16 and 20, the H-H line denotes an intersection line between the horizontal plane including the optical axis Ax and the virtual plane, and the V-V line denotes an intersection line between the vertical plane including the optical axis Ax and the virtual plane. FIG. 16 illustrates a light distribution pattern P1 formed by the refraction surface 55A; FIG. 17 illustrates a light distribution pattern P2 formed by the refraction surface 56A; FIG. 18 illustrates a light distribution pattern P3 formed by the refraction surface 57A; and FIG. 19 illustrates a light distribution pattern P4 formed by the refraction surface 58A. FIG. 20 illustrates the synthesized light distribution pattern including P1 to P4.

The light distribution pattern P formed by the direct projection vehicle light 1A shown in FIGS. 16 to 20 can be a low beam light distribution pattern for the left-hand traffic, with the pattern P including the patterns P1 to P4 formed by the respective refraction surfaces 55A to 58A. The light distribution pattern P can have cut-off lines C1 and C2 at its upper edge. The cut-off line C1 is formed on the traveling side (left side) with respect to the V-V line so as to extend horizontally along the H-H line whereas the cut-off line C2 is formed on the opposite side (right side) with respect to the V-V line so as to horizontally extend slightly below the H-H line.

The light beams emitted from the light emitting device 40A at the predetermined position can be diffused in the left and right directions by the refraction surfaces 55A and 57A when observed within a horizontal plane. Thereby, the light distribution patterns P1 and P3 can be formed so as to extend in the left and right directions as shown in FIGS. 16, 18, and 20.

The light beams emitted from the light emitting device 40A at the predetermined position can be projected through the refraction surface 56A leftward with respect to the vertical plane and diffused leftward. Thereby, the light distribution pattern P2 can be formed so as to extend in the left direction from the V-V line as shown in FIGS. 17 and 20.

The light beams emitted from the light emitting device 40A at the predetermined position can be projected through the refraction surface 58A not (substantially or totally not) rightward but projected leftward with respect to the vertical plane. Thereby, the light distribution pattern P4 can be formed so as to extend in the left direction from the V-V line as shown in FIGS. 19 and 20. When observed within a horizontal plane, the deflection angle of the light beams emitted from a predetermined position of the light emitting device 40A and being projected through the refraction surface 58A (deflection angle with respect to the vertical plane leftward) becomes large as the exit position is farther leftward away from the optical axis Ax, so that the light distribution pattern P4 can be formed to extend leftward from the V-V line.

Accordingly, the synthesized light distribution pattern P from the patterns P1 to P4 can be formed to extend in the left and right directions from the V-V line.

In this case, the right lower refraction surface 58A can form the light distribution pattern P4 on the left side of the V-V line. This pattern formation can suppress glare generation possibly incident on an oncoming vehicle, while improving long-distance visibility on the travelling side of the road.

The deflection angle of the light beams emitted from a predetermined position of the light emitting device 40A and being projected through the refraction surfaces 55A, 56A, 57A, and 58A downward with respect to the horizontal plane becomes larger as the exit position is farther away from the optical axis Ax in the upper and lower directions, so that the light distribution pattern P can be formed to extend downward from the H-H line. This means that the light distribution pattern P can have a brighter area near the H-H line and a darker area in a downward direction farther from the H-H line.

Accordingly, there may be no remarkable bright-dark boundary formed between the farther side and the nearer side, thereby improving the near-side visibility for a driver.

The cut-off lines C1 and C2 can be formed by the lower side of the light emitting device 40A. Herein, the cut-off line C1 can be formed by the projection image of the lower side and around there of the light emitting device 40A through the refraction surfaces 55A, 56A, and 58A while the cut-off line C1 can be formed by the projection image of the lower side and around there of the light emitting device 40A through the refraction surface 57A.

Since the right-upper refraction surface 57A can be configured so as to deflect the exiting light beams more downward than the left refraction surfaces 55A and 56A, the cut-off line C1 can be formed above the cut-off line C2. Namely, the refraction surfaces 55A, 56A, and 58A can project the incident light beams emitted from the light emitting device 40A and which are incident on the light incident surface 51A on a region on or below the H-H line (cut-off line C1) as an upper limit when observed within a vertical plane. On the other hand, the refraction surface 57A can project the incident light beams emitted from the light emitting device 40A and which are incident on the light incident surface 51A on a region on or below a predetermined position (corresponding to the cut-off line C2) below the H-H line, with the predetermined position being an upper limit when observed within a vertical plane.

Furthermore, the light distribution pattern P4 formed by the light beams projected through the right-lower refraction surface 58A can contribute to form the cut-off line C1 on the traveling side road similar to the projection light beams through the left refraction surfaces 55A and 56A. Accordingly, the direct projection vehicle light 1A may improve the long-distance visibility as compared with the direct projection vehicle light 1 according to the first exemplary embodiment in terms of increased light beams projected on the travelling side of the road.

As described above, since the cut-off line C1 can be formed above the cut-off line C2, the visibility near the traveling side road can be ensured while glare light can be prevented from being generated toward the opposite side of the road. Accordingly, the direct projection vehicle light 1A can be utilized as a low beam headlamp.

The present exemplary embodiment has dealt with the case where the direct projection vehicle light 1A is for the left-hand traffic, which is not limitative. If the direct projection vehicle light 1A is used as that for the right-hand traffic, the design can be reversed horizontally.

The present exemplary embodiment has dealt with the case where the light incident surface 51A has a flat surface, which is not limitative. The light incident surface 51A may have a cylindrical surface, a spherical surface, an aspherical surface, a free curved surface, or other known surface. The light exiting surface 52A can have a curved surface corresponding to the light incident surface 51A so that the required refraction can be achieved on the exiting light beams through the light exiting surface 52A.

### Third Exemplary Embodiment

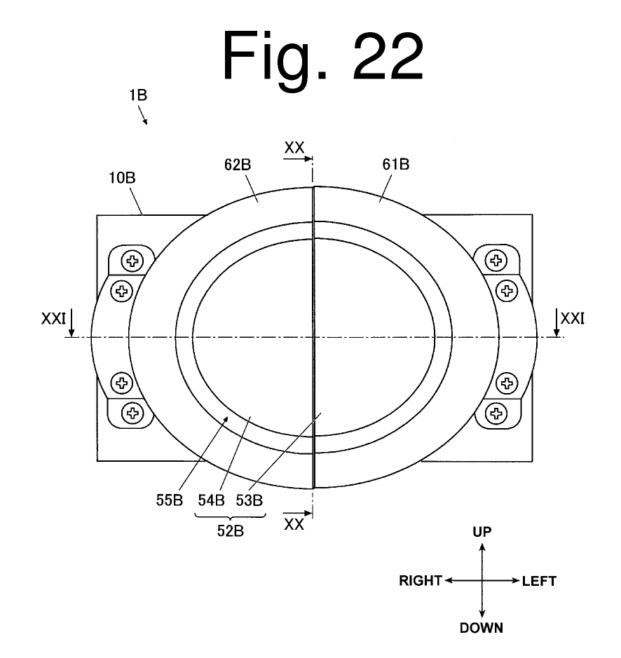

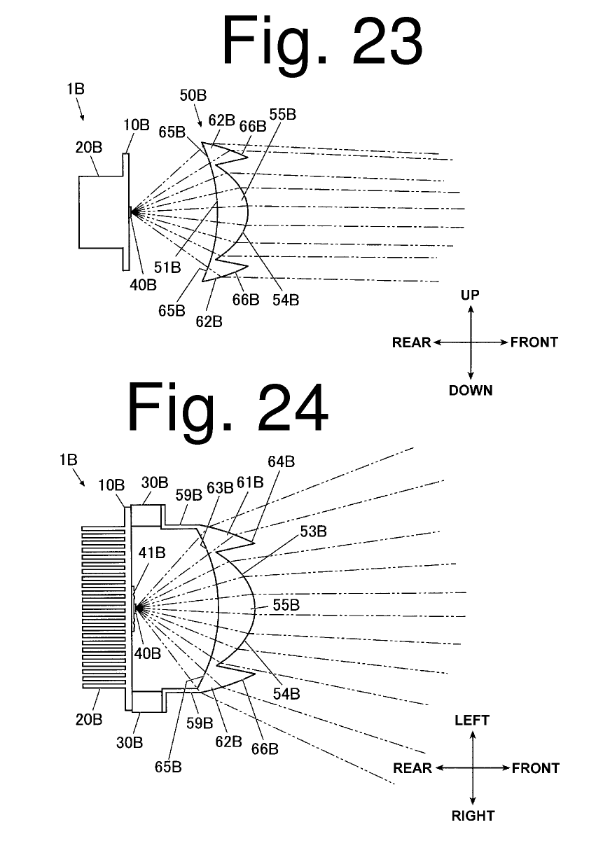

FIG. 21 is a perspective view illustrating a direct projection vehicle light 1B according to still another exemplary embodiment of the presently disclosed subject matter. FIG. 22 is a front view illustrating the direct projection vehicle light 1B. FIG. 23 is a cross sectional view illustrating the vehicle light 1B taken along line XX-XX in FIG. 22. FIG. 24 is a cross sectional view illustrating the vehicle light 1B taken along line XXI-XXI in FIG. 22.

In the illustrated exemplary embodiment, the direct projection vehicle light 1B is used for a low beam vehicle headlamp for the left-hand traffic.

As shown, the direct projection vehicle light 1B can include a support plate 10B, a plurality of heat dissipation fins 20B, a lens holder 30B, a light emitting device 40B, and a projection lens 50B.

The support plate 10B and the plurality of heat dissipation fins 20B can be provided in the same or similar manner as in the first exemplary embodiment.

The light emitting device 40B can be disposed via a substrate 41B on the front surface of the support plate 10B in the same or similar manner as in the first exemplary embodiment. In this instance, the shape, arranged position, and arranged direction of the light emitting device 40B can be the same or similar as those of the first exemplary embodiment.

The projection lens 50B can be attached to the support plate 10B by means of leg portions 59B and the lens holder 30B and disposed in front of the light emitting device 40B in the same or similar manner as in the first exemplary embodiment.

The projection lens 50B can be disposed on an optical axis that extends forward from the light emitting device 40B. In the present exemplary embodiment, the projection lens 50 can be a convex lens having a plurality of divided light exiting surface. Specifically, the projection lens 50B can have a center convex lens portion 55B, a first prism portion 61B disposed on the periphery of the center convex lens portion 55B and on the left side of the optical axis, and a second prism portion 62B disposed on the periphery of the center convex lens portion 55B and on the right side of the optical axis, with the first and second prism portions 61B and 62B being concentric with the convex lens portion 55B.

The center convex lens portion 55B can have a light incident surface 51B and a light exiting surface 52B on the rear and front side thereof, respectively. The light incident surface 51B can receive the direct light emitted from the light emitting device 40B. The light exiting surface 52B can project the entering light forward. In this exemplary embodiment, the rear light incident surface 51B can be a spherical concave surface while the light exiting surface 52B can be an aspherical convex surface. Furthermore, the light exiting surface 52B can be divided into a left refraction surface 53B and a right refraction surface 54B.

The first prism portion 61B can have a light incident surface 63B and a light exiting surface 64B on the rear and front sides thereof, respectively. The light incident surface 63B can receive the direct light emitted from the light emitting device 40B. The light exiting surface 64B can project the entering light forward. In this exemplary embodiment, the light incident surface 63B can be a spherical concave surface and can be flush with the light incident surface 51B. The light exiting surface 64B can be an aspherical convex surface.

The second prism portion 62B can have a light incident surface 65B and a light exiting surface 66B on the rear and front side thereof, respectively. The light incident surface 65B can receive the direct light emitted from the light emitting device 40B. The light exiting surface 66B can project the entering light forward. In this exemplary embodiment, the light incident surface 65B can be a spherical concave surface and be flush with the light incident surface 51B. The light exiting surface 66B can be an aspherical convex surface.

In FIGS. 23 and 24, the chain double-dashed line denotes light beams emitted from the light emitting device 40B at a predetermined position (for example, the center of the light emitting device 40B, the center lower side of the device 40B, or the like).

The convex lens portion 55B can have the same or similar optical characteristics as those of the projection lens 50 in the first exemplary embodiment.

Specifically, as shown in FIG. 24, the light exiting surface 52B of the convex lens portion 55B can be configured so as to project the incident light beams emitted from the predetermined position of the light emitting device 40B and which are incident on the light incident surface 51B while diffusing the light beams in both right and left directions when observed within a horizontal plane.

Furthermore, as shown in FIG. 23, the left refraction surface 53B of the convex lens portion 55B can project incident light beams emitted from the light emitting device 40B at the predetermined position and which are incident on the light incident surface 51B “not on a region” above the horizontal plane but on a region below the horizontal plane and along the horizontal plane. On the other hand, the right refraction surface 54B of the convex lens portion 55B can project incident light beams emitted from the light emitting device 40B at the predetermined position and being incident on the light incident surface 51B “not on a region” above the horizontal plane but on a region below the horizontal plane. In this case, the right refraction surface 54B can deflect the incident light beams lower than the left refraction surface 53B.

Furthermore, the light beams emitted from the light emitting device 40B at the predetermined position and which are projected through the left refraction surface 53B can be deflected downward by a larger deflection angle with respect to the horizontal plane as the exit position is farther away from the optical axis in the upper and lower directions. Similarly, the light beams emitted from the light emitting device 40B at the predetermined position and being projected through the right refraction surface 54B can also be deflected downward by a larger deflection angle with respect to the horizontal plane as the exit position is farther away from the optical axis in the upper direction.

As shown in FIG. 24, the light exiting surface 64B of the first prism portion 61B can be configured so as to avoid substantially projecting or not to project light beams emitted from the light emitting device 40B at a predetermined position and which are incident on the light incident surface 63B rightward with respect to the vertical plane but so as to project the light beams leftward while diffusing the light beams leftward when observed within a horizontal plane. In addition to this, the light exiting surface 64B can be configured so as to avoid substantially projecting or not to project the light beams upward with respect to the horizontal plane but so as to project the light beams downward when observed within a vertical plane. In this case, the light beams emitted from the light emitting device 40B at the predetermined position and which are projected through the light exiting surface 64B can be deflected downward by a larger deflection angle with respect to the horizontal plane as the exit position is farther away from the optical axis in the upper and lower directions.

As shown in FIG. 24, the light exiting surface 66B of the second prism portion 62B can be configured so as to avoid substantially projecting or not to project the light beams emitted from the light emitting device 40B at a predetermined position and which are incident on the light incident surface 65B leftward with respect to the vertical plane but so as to project the light beams rightward while diffusing the light beams rightward within the horizontal plane. In addition to this, as shown in FIG. 23, the light exiting surface 66B can be configured so as to avoid substantially projecting or not to project the light beams upward with respect to the horizontal plane but so as to project the light beams downward when observed within a vertical plane. In this case, the light beams emitted from the light emitting device 40B at the predetermined position and which are projected through the light exiting surface 66B can be deflected downward by a larger deflection angle with respect to the horizontal plane as the exit position is farther away from the optical axis in the upper and lower directions.

The light exiting surface 64B of the first prism portion 61B and the light exiting surface 66B of the second prism portion 62B can deflect the incident light beams more downward than the left refraction surface 53B. On the other hand, the light exiting surfaces 64B and 66B and the right refraction surface 54B can deflect the incident light beams almost in a similar manner with respect to each other.

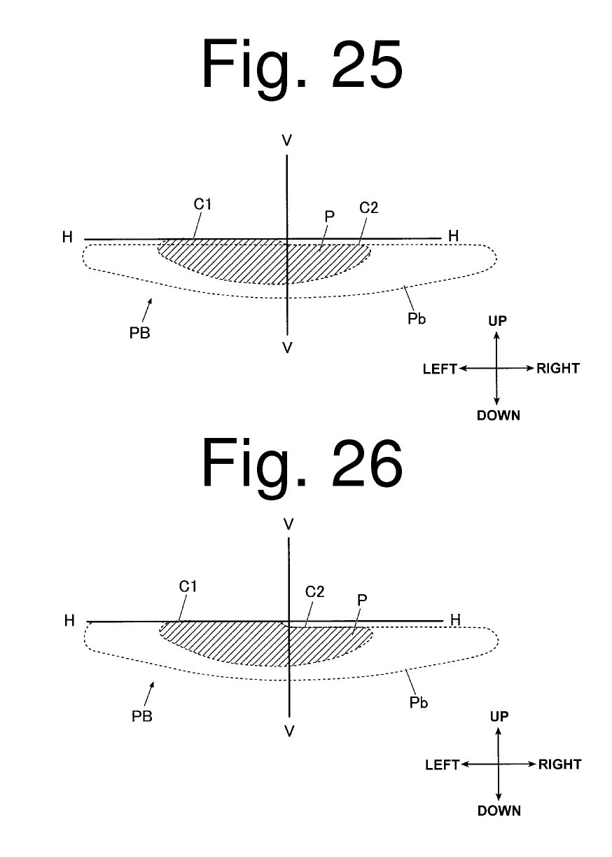

FIG. 25 is a diagram of a light distribution pattern PB formed by the direct projection vehicle light 1B on a virtual plane assumed to be positioned away from the direct projection vehicle light 1B by a predetermined distance. In FIG. 25, the H-H line denotes an intersection line between the horizontal plane including the optical axis and the virtual plane, and the V-V line denotes an intersection line between the vertical plane including the optical axis and the virtual plane.

The light distribution pattern PB formed by the direct projection vehicle light 1B shown in FIG. 25 can be a low beam light distribution pattern for the left-hand traffic, with the pattern PB including the light distribution pattern P formed by the convex lens portion 55B and a light distribution pattern Pb formed by the prism portions 61B and 62B. The light distribution pattern PB can have cut-off lines C1 and C2 at its upper edge. The cut-off line C1 is formed on the traveling side (left side) with respect to the V-V line so as to extend horizontally along the H-H line whereas the cut-off line C2 is formed on the opposite side (right side) with respect to the V-V line so as to horizontally extend slightly below the H-H line.

Since the optical characteristics of the convex lens portion 55B can be similar or the same as those of the projection lens 50 in the first exemplary embodiment, the light distribution pattern P formed by the convex lens portion 55B can be formed similar to or the same as that formed by the projection lens 50 in the first exemplary embodiment.

The light exiting surface 64B of the first prism portion 61B can project incident light beams emitted from the light emitting device 40B at the predetermined position and which are incident on the light incident surface 63B on a region below the horizontal plane when observed within a vertical plane. At the same time, the light exiting surface 66B of the second prism portion 62B can project incident light beams emitted from the light emitting device 40B at the predetermined position and being incident on the light incident surface 65B on a region below the horizontal plane when observed within a vertical plane. Accordingly, the cut-off line CD1 can be formed below the upper edge (bright-dark boundary line) of the light distribution pattern Pb. Namely, the light exiting surface 64B of the first prism portion 61B and the light exiting surface 66B of the second prism portion 62B can project the incident light beams emitted from the light emitting device 40B and which are incident on the respective light incident surfaces 63B and 65B on a region on or below a predetermined position (corresponding to the cut-off line C2) below the H-H line, with the predetermined position being an upper limit when observed within a vertical plane.

Furthermore, since the light exiting surface 64B of the first prism portion 61B and the light exiting surface 66B of the second prism portion 62B can deflect the incident light beams more downward than the left refraction surface 53B, the upper edge (bright-dark boundary line) of the light distribution pattern Pb can be formed below the cut-off line C1.

In addition, since the light exiting surfaces 64B and 66B and the right refraction surface 54B can deflect the incident light beams almost in the same or similar manner with respect to each other, the upper edge of the light distribution pattern Pb can be arranged on the cut-off line C2.

The deflection angle of the light beams projected through the light exiting surfaces 64B and 66B downward with respect to the horizontal plane as a reference becomes larger as the exit position is farther away from the optical axis in the upper and lower directions, so that the light distribution pattern Pb can be formed to extend downward from the H-H line. Furthermore, the light distribution pattern Pb can have a brighter area near the H-H line and a darker area as it is downwardly farther from the H-H line.

The light beams emitted from the light emitting device 40B at a predetermined position and which are incident on the light incident surface 63B can be projected through the light exiting surface 64B of the first prism portion 61B leftward with respect to the vertical plane and diffused leftward when observed within a horizontal plane. At the same time, the light beams emitted from the light emitting device 40B at a predetermined position and which are incident on the light incident surface 65B can be projected through the light exiting surface 66B of the second prism portion 62B rightward and diffused leftward when observed within a horizontal plane. Thereby, the light distribution pattern Pb can be formed so as to extend in the left and right directions.

As described above, since the first and second prism portions 61B and 62B can be provided to surround the convex lens portion 55B, the light distribution pattern P can be compensated with the additional light distribution pattern Pb to generate a wider uniform light distribution pattern PB. Since the projection lens 50B can be a convex lens of Fresnel lens type, an increase in thickness of the projection lens 50B can be suppressed, thereby increasing the aperture of the lens 50B. As a result, a brighter and wider light distribution pattern PB can be achieved.

It should be noted that the light exiting surface 66B of the second prism portion 62B and the right refraction surface 54B may deflect the light beams emitted from the light emitting device 40B almost in the same or similar manner with respect to each other, and the light exiting surface 64B of the first prism portion 61B and the left refraction surface 53B may deflect the light beams emitted from the light emitting device 40B almost in the same or similar manner with respect to each other while the light exiting surface 66B of the second prism portion 62B and the right refraction surface 54B may deflect the incident light beams more downward than the light exiting surface 64B of the first prism portion 61B and the left refraction surface 53B.

In this case, the light distribution pattern PB as shown in FIG. 26 can be formed. In this case, since the light exiting surfaces 64B of the first prism portion 61B and the left refraction surface 53B can deflect the incident light beams almost in the same or similar manner with respect to each other, the upper edge of the light distribution pattern Pb on the left side with respect to the V-V line can be arranged on the cut-off line C1. Note that the light distribution pattern Pb on the left side with respect to the V-V line can be formed by the light exiting surface 64B of the first prism portion 61B. Namely, the light exiting surface 64B of the first prism portion 61B can project the incident light beams emitted from the light emitting device 40B and which are incident on the light incident surface 63B on a region on or below the H-H line (corresponding to the cut-off line C1), with the H-H line being an upper limit when observed within a vertical plane. In addition, since the light exiting surfaces 66B of the second prism portion 62B and the right refraction surface 54B can deflect the incident light beams almost in the same or similar manner with respect to each other, the upper edge of the light distribution pattern Pb on the right side with respect to the V-V line can be arranged on the cut-off line C2. Note that the light distribution pattern Pb on the right side with respect to the V-V line can be formed by the light exiting surface 66B of the second prism portion 62B. Namely, the light exiting surface 66B of the second prism portion 62B can project the incident light beams emitted from the light emitting device 40B and which are incident on the light incident surface 65B on a region on or below the H-H line (corresponding to the cut-off line C2), with the H-H line being an upper limit. In the above exemplary embodiment, the convex lens portion 55B of the projection lens 50B can have the same or similar optical characteristics as the projection lens 50 of the first exemplary embodiment, but this configuration is not limitative. The convex lens portion 55B can also have the same or similar optical characteristics as the projection lens 50A of the second exemplary embodiment.

The present exemplary embodiment has dealt with the case where the direct projection vehicle light 1B is for the left-hand traffic, which is not limitative. If the direct projection vehicle light 1B is used as that for the right-hand traffic, the design can be reversed horizontally.

The present exemplary embodiment has dealt with the case where the light incident surfaces 51B, 63B, and 65B each have a spherical surface, which is not limitative. The light incident surfaces may have a flat surface, a cylindrical surface, an aspherical surface, a free curved surface, or other known surface shape. The light exiting surfaces 52B, 64B, and 66B can have a curved surface corresponding to the respective light incident surfaces 51B, 63B, and 65B so that the required refraction can be achieved on the exiting light beams through the light exiting surfaces 52B, 64B, and 66B.

It will be apparent to those skilled in the art that various modifications and variations can be made in the presently disclosed subject matter without departing from the spirit or scope of the presently disclosed subject matter. Thus, it is intended that the presently disclosed subject matter cover the modifications and variations of the presently disclosed subject matter provided they come within the scope of the appended claims and their equivalents. All related art references described above are hereby incorporated in their entirety by reference.

What is claimed is:

1. A vehicle light comprising:
a light emitting device having an optical axis extending in a front direction therefrom; and
a projection lens disposed on the optical axis, and configured to project light beams emitted from the light emitting device, wherein:
the projection lens includes a light incident surface on a rear side thereof and a light exiting surface on a front side thereof, the light incident surface configured to receive the light beams emitted from the light emitting device, the light exiting surface configured to project the light beams forward;
the light exiting surface configured to project the light beams emitted from the light emitting device and which are incident on the light incident surface while diffusing the light beams in both right and left directions when observed within a horizontal plane;
the light exiting surface configured to include a first refraction surface in a region on a first side of the vehicle light and a second refraction surface in a region on an opposite side of the vehicle light;
the first refraction surface configured to project the light beams emitted from the light emitting device and which are incident on the light incident surface on a lower region than a horizontal plane including the optical axis with the horizontal plane serving as an upper limit when observed within a vertical plane;
the second refraction surface configured to project the light beams emitted from the light emitting device and which are incident on the light incident surface on a lower region than a predetermined position below the horizontal plane with the predetermined position serving as an upper limit when observed within a vertical plane;
the first refraction surface configured to deflect the light beams emitted from the light emitting device downward by a larger deflection angle with respect to the horizontal plane as an exit position of the light beams is farther away from the optical axis in upper and lower directions; and
the second refraction surface is configured to deflect the light beams emitted from the light emitting device downward by a larger deflection angle with respect to the horizontal plane as an exit position of light beams is farther away from the optical axis in the upper and lower directions.

2. The vehicle light according to claim 1, wherein:
the projection lens includes a first prism portion and a second prism portion, the first prism portion being disposed on a periphery of the light incident surface and the light exiting surface on the first side of the vehicle light with respect to the optical axis, the second prism portion being disposed on the periphery of the light incident surface and the light exiting surface on an opposite side with respect to the optical axis;
the first prism portion includes a first prism light incident surface on a rear side of the first prism portion and a first prism light exiting surface on a front side of the first prism portion, the first prism light incident surface configured to receive at least a first portion of the light beams emitted from the light emitting device, the first prism light exiting surface configured to project the first portion of the light beams forward;
the second prism portion includes a second prism light incident surface on a rear side of the second prism portion and a second prism light exiting surface on a front side of the second prism portion, the second prism light incident surface configured to receive at least a second portion of the light beams emitted from the light emitting device, the second prism light exiting surface configured to project the second portion of the light beams forward;
the first prism light exiting surface configured so as not to substantially project the first portion of light beams emitted from the light emitting device and incident on the first prism light incident surface on the opposite side of the vehicle light with respect to a vertical plane and so as to project the first portion of light beams on the traveling side of the vehicle light with respect to the vertical plane when observed within a horizontal plane;
the first prism light exiting surface configured to project the first portion of light beams emitted from the light emitting device and incident on the first prism light incident surface on a lower region than a predetermined position below the horizontal plane including the optical axis with the predetermined position serving as an upper limit when observed within a vertical plane;
the first prism light exiting surface configured to deflect the first portion of light beams emitted from the light emitting device downward by a larger deflection angle with respect to the horizontal plane as an exit position of the first portion of light beams is farther away from the optical axis in upper and lower directions;
the second prism light exiting surface configured so as not to substantially project the second portion of light beams emitted from the light emitting device and incident on the second prism light incident surface on the first side of the vehicle light with respect to the vertical plane and so as to project the second portion of light beams on the opposite side of the vehicle light with respect to the vertical plane when observed within a horizontal plane;
the second prism light exiting surface configured to project the second portion of incident light beams emitted from the light emitting device and incident on the second prism light incident surface on a lower region than a predetermined position below the horizontal plane with the predetermined position serving as an upper limit when observed within a vertical plane; and
the second prism light exiting surface configured to deflect the second portion of light beams emitted from the light emitting device downward by a larger deflection angle with respect to the horizontal plane as an exit position of the second portion of light beams is farther away from the optical axis in the upper and lower directions.

3. A vehicle light comprising:
a light emitting device having an optical axis extending in a front direction therefrom; and
a projection lens disposed on the optical axis, and configured to project light beams emitted from the light emitting device, wherein:
the projection lens includes a light incident surface on a rear side of the projection lens and a light exiting surface on a front side of the projection lens, the light incident surface configured to receive light beams emitted from the light emitting device, the light exiting surface configured to project the light beams forward;
the light exiting surface configured to include an upper first refraction surface in an upper region on a first side of the vehicle light, a lower first refraction surface in a lower region on the first side of the vehicle light, an upper second refraction surface in an upper region on an opposite side of the vehicle light, and a lower second refraction surface in a lower region on the opposite side of the vehicle light;
the upper first refraction surface and the upper second refraction surface configured so as to project light beams emitted from the light emitting device and which are incident on the light incident surface while diffusing light beams in both right and left directions when observed within a horizontal plane;
the lower first refraction surface and the lower second refraction surface configured so as not to substantially project light beams emitted from the light emitting device and which are incident on the light incident surface on the opposite side of the vehicle light with respect to a vertical plane and so as to project light beams on the first side of the vehicle light with respect to the vertical plane when observed within a horizontal plane;
the upper first refraction surface, the lower first refraction surface, and the lower second refraction surface are configured to project light beams emitted from the light emitting device and which are incident on the light incident surface on a lower region lower than a horizontal plane including the optical axis with the horizontal plane serving as an upper limit when observed within a vertical plane;
the upper second refraction surface configured to project light beams emitted from the light emitting device and which are incident on the light incident surface on a lower region lower than a predetermined position below the horizontal plane with the predetermined position serving as an upper limit when observed within a vertical plane;
the upper first refraction surface, the lower first refraction surface, and the lower second refraction surface are configured to deflect light beams emitted from the light emitting device downward by a larger deflection angle with respect to the horizontal plane as an exit position of the light beams is farther away from the optical axis in upper and lower directions; and
the upper second refraction surface configured to deflect the light beams emitted from the light emitting device downward by a larger deflection angle with respect to the horizontal plane as an exit position of the light beams is farther away from the optical axis in the upper direction.

4. The vehicle light according to claim 3, wherein:
the projection lens includes a first prism portion and a second prism portion, the first prism portion being disposed on a periphery of the light incident surface and the light exiting surface on the first side of the vehicle light with respect to the optical axis, the second prism portion being disposed on the periphery of the light incident surface and the light exiting surface on the opposite side of the vehicle light with respect to the optical axis;
the first prism portion configured to include a first prism light incident surface on a rear side of the first prism portion and a first prism light exiting surface on a front side of the first prism portion, the first prism light incident surface configured to receive light beams emitted from the light emitting device, the first prism light exiting surface configured to project the light beams forward;
the second prism portion includes a second prism light incident surface on a rear side of the second prism portion and a second prism light exiting surface on a front side of the second prism portion, the second prism light incident surface configured to receive light beams emitted from the light emitting device, the second prism light exiting surface configured to project the light beams forward;
the first prism light exiting surface configured so as not to substantially project light beams emitted from the light emitting device and which are incident on the first prism light incident surface on the opposite side of the vehicle light with respect to a vertical plane and so as to project light beams on the first side of the vehicle light with respect to the vertical plane within the horizontal plane;
the first prism light exiting surface configured to project light beams emitted from the light emitting device and which are incident on the first prism light incident surface on a lower region than a predetermined position below the horizontal plane including the optical axis with the predetermined position serving as an upper limit within the vertical plane;
the first prism light exiting surface configured to deflect light beams emitted from the light emitting device downward by a larger deflection angle with respect to the horizontal plane as an exit position of the light beams is farther away from the optical axis in upper and lower directions;
the second prism light exiting surface configured so as not to substantially project light beams emitted from the light emitting device and which are incident on the second prism light incident surface on the first side of the vehicle light with respect to the vertical plane and so as to project the light beams on the opposite side of the vehicle light with respect to the vertical plane within the horizontal plane;
the second prism light exiting surface configured to project light beams emitted from the light emitting device and which are incident on the second prism light incident surface on a lower region than a predetermined position below the horizontal plane including the optical axis with the predetermined position serving as an upper limit within the horizontal plane; and
the second prism light exiting surface configured to deflect light beams emitted from the light emitting device downward by a larger deflection angle with respect to the horizontal plane as an exit position of the light beams is farther away from the optical axis in the upper and lower directions.

5. The vehicle light according to claim 1, further comprising:
a support plate including a front surface at which the light emitting device is located; and
heat dissipation fins located at a rear surface of the support plate, and wherein the projection lens has leg portions that are secured to the support plate.

6. The vehicle light according to claim 2, further comprising:
a support plate including a front surface at which the light emitting device is located; and
heat dissipation fins located at a rear surface of the support plate, and wherein the projection lens has leg portions that are secured to the support plate.

7. The vehicle light according to claim 3, further comprising:
a support plate including a front surface at which the light emitting device is located; and
heat dissipation fins located at a rear surface of the support plate, and wherein the projection lens has leg portions that are secured to the support plate.

8. The vehicle light according to claim 4, further comprising:
a support plate including a front surface at which the light emitting device is located; and
heat dissipation fins located at a rear surface of the support plate, and wherein the projection lens has leg portions that are secured to the support plate.

9. The vehicle light according to claim 1, wherein the light incident surface has a cylindrical concave surface curved horizontally so that a rotation axis of the cylindrical concave surface extends in a vertical direction.

10. The vehicle light according to claim 2, wherein the light incident surface has a cylindrical concave surface curved horizontally so that a rotation axis of the cylindrical concave surface extends in a vertical direction.

11. The vehicle light according to claim 3, wherein the light incident surface has a cylindrical concave surface curved horizontally so that a rotation axis of the cylindrical concave surface extends in a vertical direction.

12. The vehicle light according to claim 4, wherein the light incident surface has a cylindrical concave surface curved horizontally so that a rotation axis of the cylindrical concave surface extends in a vertical direction.

13. The vehicle light according to claim 5, wherein the light incident surface has a cylindrical concave surface curved horizontally so that a rotation axis of the cylindrical concave surface extends in a vertical direction.

14. The vehicle light according to claim 7, wherein the light incident surface has a cylindrical concave surface curved horizontally so that a rotation axis of the cylindrical concave surface extends in a vertical direction.

15. The vehicle light according to claim 1, wherein the first side of the vehicle light corresponds to a side closest to a travelling side of a road.

16. The vehicle light according to claim 3, wherein the first side of the vehicle light corresponds to a side closest to a travelling side of a road.
